(19) United States
(12) Patent Application Publication
(10) Pub. No.: US 2005/0117232 A1
(43) Pub. Date: Jun. 2, 2005

(54) Rheologic mirror

(76) Inventor: Steven James Forsberg, Spring, TX (US)

Correspondence Address: Steven J. Forsberg, 555 Spring Park Ctr Blvd 9202, Spring, TX, 77373, US

(21) Appl. No.: 10/962,113

(22) Filed: Oct. 8, 2004

Related U.S. Application Data
(60) Provisional application No. 60/510,069, filed on Oct. 9, 2003.

(51) Int. Cl. G02F 1/1335; G02B 5/08

(52) U.S. Cl. 359/843

(57) ABSTRACT

A liquid mirror such as that utilized by liquid mirror telescopes, using a magnetorheologic fluid as said liquid, and with a means of introducing or withdrawing a magnetic field whereby said magnetorheologic fluid can change phase.

### CROSS-REFERENCE TO RELATED APPLICATIONS

This application claims the benefit of Provisional Patent Application Ser. No. 60/510,069 filed Oct. 8, 2003.

### BACKGROUND

1. Field of the Invention

This invention relates to mirrors, specifically rheologic mirrors whose reflective surface can be phase changed back and forth between liquid and solid/plastic.

2. Description of Prior Art

Mirrors can be difficult and expensive to manufacture. This is particularly true for applications that require large mirrors, such as telescopes. These difficulties are compounded when the mirror must be used in a situation with tight weight and volume restrictions, such as aboard a spacecraft.

One of the approaches used to try and mitigate the difficulties and expenses associated with large mirrors is the development of the liquid mirror, as used in the Liquid Mirror Telescope (LMT). According to the laws of Newtonian physics, it is possible for a fluid surface to serve as a mirror with a high optical quality. Furthermore, a desired parabolic shape can be formed by rotating the liquid in a uniform gravitational field. Wood (see Wood, R. W. 1909, ApJ, 29, 164) showed that if mercury was used as the liquid, in theory mirrors of optical quality could be produced at low cost. Technical difficulties such as ripples in the fluid have been addressed by Borra (see E. F. Borra, “The Liquid-Mirror Telescope As A Viable Astronomical Tool” JRASC 1982, 76, 245). The resultant LMTs, with reflective surfaces of liquid mercury spun about an axis, have been of great use in the astronomical field.

The traditional liquid mirror has some severe limitations, however. The reflective surface is made of liquid, and accordingly if the container holding it is tipped the liquid will run off. The need to keep the liquid nearly perpendicular to the pull of gravity limits such mirrors to pointing near vertical. In addition, in order to maintain the desired parabolic shape the liquid must be kept continuously rotating. Finally, the element mercury poses environmental and safety problems. There have been various innovations to mitigate these limitations, but they still substantially limit the utility of the liquid mirror for many applications.

There have been efforts to make large mirrors by spin casting using materials such as epoxy resin. Such spin casting methods, however, are a one time process and the mirrors they produce can not change phase back and forth. In addition, there are other limitations on traditional spin casting. For example, because they utilize heat (instead of magnetism) to incur a phase change in the epoxy, the resultant large co-efficient of thermal expansion makes it difficult to properly form the mirror. As a practical matter, spin casting with epoxy or polymer resins is limited to mirrors of under 2 meters in diameter.

In order to deal with severe weight and volume restrictions on applications in space, there have been efforts to create folding mirrors. Such mirrors could be folded into a compact space and then expanded to proper form once in space. A key problem, however, is trying to get the unfolded mirror to within the desired tolerances. Basically, creases and folds are left on the unfolded mirror, impacting effectiveness. In addition, mechanisms for unfolding and supporting such mirrors can be complex or sizeable themselves.

Thus, liquid mirrors are economic but limited in their applicability due to their physical limitations. These limitations preclude, among other things, practical usage in a space environment. In addition, even the creation of large conventional mirrors in space remains problematic.

Rheologic fluids are a class of so called “smart materials.” While they are normally found in fluid phase, they change to a solid/plastic phase with the application of the appropriate field. The particular implementation described in this invention utilizes magnetorheologic fluids, which change phase upon the application of a magnetic field. Such materials are often made of zeolites or metals coated with oxides or polymers. When a magnetic field is applied the viscosity of the material can increase by a factor of 10 to the 5^{th} power, effectively changing the phase from liquid to solid or plastic. This phase change can occur as quickly as one to ten milliseconds. Magnetorheologic fluids have found a number of applications, mainly in shock reducing or power transmission roles, and are commercially available with a wide variety of specifications. One familiar with the state of the art for such materials could substitute other rheologic fluids, such as electrorheologic fluids, with appropriate changes.

This invention is very different than the one described in U.S. Pat. No. 5,650,880 “Ferro-fluid mirror with shape determined in part by an inhomogenous field.” That invention utilizes ferro-fluids, which do not change phase. Likewise, other attempts to replace mercury in liquid mirrors such as in U.S. Pat. No. 5,792,236 “Non-toxic liquid metal composition for use as a mercury substitute” do not envision the use of phase changing smart materials such as magnetorheologic fluid.

### SUMMARY

This invention is a novel and unobvious combination of the existing techniques and technologies of the liquid mirror telescope with that of magnetorheologic materials. In accordance with the present invention, a magnetorheologic fluid is utilized as the fluid in the liquid mirror. A magnetic field can then be produced which changes the phase of the magnetorheologic fluid to a solid or a plastic.

### OBJECTS AND ADVANTAGES

Accordingly, the current invention has several objects and advantages:
(a) To produce a mirrored surface by rotating a magnetorheologic fluid as is done with a liquid mirror, and where the phase of the magnetorheologic fluid can be changed back and forth between solid/plastic and liquid by the application and withdrawal of an appropriate electromagnetic field.
(b) To produce a mirror utilizing the economically efficient method used by liquid mirror telescopes, but capable of overcoming the liquid mirror's limitations by having the reflective surface change phase back and forth between a solid and a liquid at will.
(c) To produce a mirror that is well suited to efficient transport and subsequent erection in situ. Any given volume and shape of space can be efficiently filled by a liquid, and the liquid can be subsequently shaped with no deformation. Thus, the magnetorheologic fluid in this invention can be transported and formed as a liquid, and then solidified for use.
(d) To produce a mirror whose surface can be relatively easily re-formed in order to change mirror parameters or to correct defects such as scratches, surface contamination, or scorching.

### DRAWING FIGURES

FIG. 1 is a cross-sectional view of the liquid container of the invention.

FIG. 2 is a diagram of the physical principles of spinning liquid mirrors.

### REFERENCE NUMERALS IN DRAWINGS

| | |
|---|---|
| 10 hub | 50 polyesier surface |
| 20 styrofoam core | 60 electromagnets |
| 30 Kevlar skin | 40 aluminum ring |

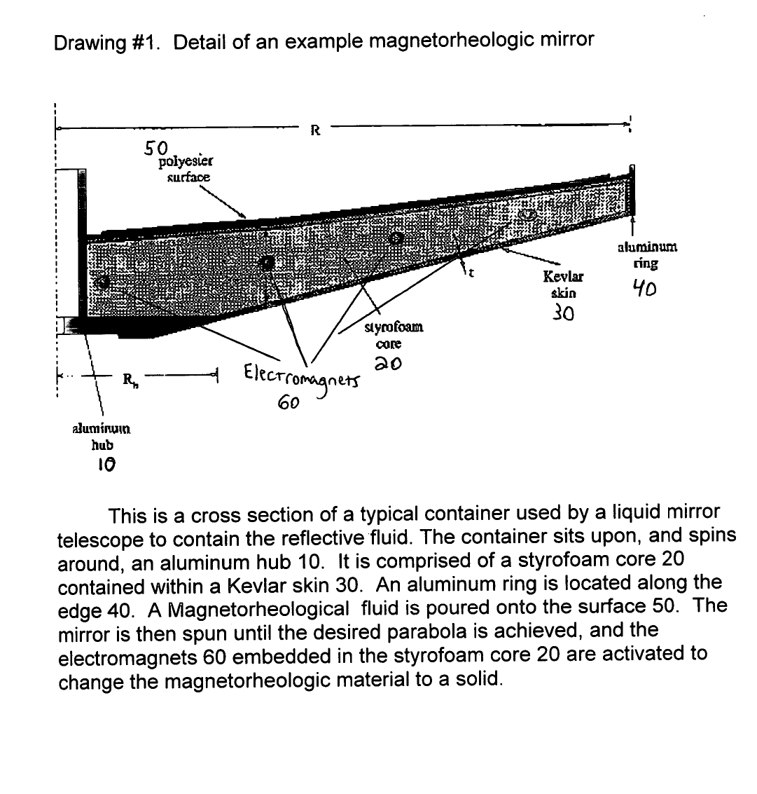

### DESCRIPTION—FIG. 1—PREFERRED EMBODIMENT

A preferred embodiment of the invention is illustrated in FIG. 1. It is a cross sectional view of the container used in a typical liquid mirror to hold said liquid. The container is set upon, and spins about, a hub 10. The container has a styrofoam core 20 in order to provide lightweight support for the magnetorheologic fluid which is applied on the surface 50. A kevlar skin 30 surrounds the styrofoam core 20, and an aluminum ring 40 located on the circumference of the container provides for smoother rotation. Embedded within the styrofoam core 20 are electromagnets 60 which can provide the magnetic field to change the phase of the magnetorheologic fluid applied to the surface 50.

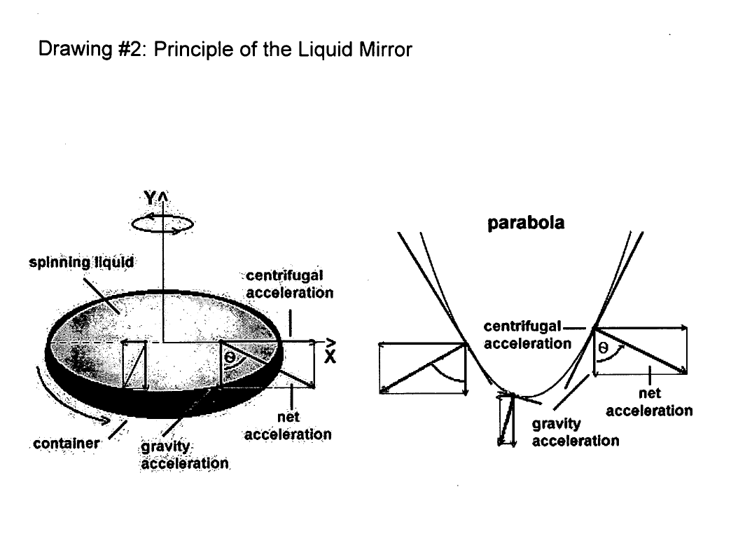

FIG. 2 illustrates the physical principles that underlie liquid mirrors.

### ALTERNATIVE EMBODIMENTS

An electrorheologic fluid could be substituted for the magnetorheologic fluid, in which case an electrical current would have to be passed through the electrorheologic fluid itself in order to obtain the desired phase change.

When magnetorheologic fluid is utilized, any number of methods may be utilized to produce the desired magnetic field. Alternative embodiments might utilize permanent magnets introduced near the magnetorheologic fluid, for example, or use magnets that are not co-located on the spinning liquid container yet are sufficiently close to produce the field.

In low or zero gravity environments, it may be necessary to utilize any of a number of methods to generate a force which replaces gravity in the functioning of the rheologic mirror. One such method is to use centrifugal force in place of gravity while the mirror is formed, by inducing the appropriate spin on a satellite.

An unfolding mirror might be utilized as the container, allowing the subsequent coating of the liquid magnetorheologic fluid to cover defects such as creases. In addition, when the magnetorheologic fluid changes phase to a solid/plastic it will assist in stiffening the unfolded mirror/container.

Advantages

From the description above, a number of advantages of my rheologic mirror become evident:
(a) When the phase of the rheologic fluid is changed to solid/plastic there is no need to continue rotating the container. In addition, the mirror can now be pointed in any direction instead of being limited to a direction perpendicular to gravity.
(b) Since the reflective surface is formed by the application of the rheologic fluid in the liquid state, the surface on which it rests can contain a certain amount of defects (creases, pits, etc.) without effecting the efficiency of the mirror.
(c) Since the rheologic fluid can be changed back and forth in phase the mirror can be reformed or the mirror surface can be replaced. Scratches, surface contamination, scorching, and other problems associated with mirror faces can be more easily and economically dealt with.
(d) The rheologic fluid can be more efficiently stored in volumes of any shape and does not suffer the unfolding problems of conventional folding mirrors.
   Operation

In operation, the rheologic mirror is similar to that of the liquid mirror of the liquid mirror telescope. However, rheologic fluid (in place of mercury or other fluids) is introduced to the container, which is spun at a speed appropriate to produce a parabola of the desired shape. The invention also has electromagnets embedded in the container. When activated they produce a magnetic field which changes the phase of the liquid to a solid. The mirror can then be utilized like a conventional solid mirror. Then, as desired, the magnetic field can be withdrawn and the rheologic fluid returns to its fluid state.

Conclusion, Ramifications, and Scope

Accordingly, the reader will see that the rheologic mirror is a novel combination of two existing technologies that solves several problems outstanding with current mirror technology. It allows large mirrors to be formed to specification economically, as with conventional liquid mirror telescopes. However, it has the advantage that once the phase is changed to solid the mirror can be pointed in any direction and does not need to continue to spin. In addition, since the reflective surface can change phase back and forth between a solid and a liquid, the surface can be re-reformed in order to correct defects such as scratches, pits, surface contamination, or scorching, or simply in order to produce a mirror with different parameters. Along these same lines, the liquid phase fluid will cover imperfections such as the creases often found on unfolded mirrors. The phase changing nature of magnetorheologic fluid also allows for efficient storage and transport of the mirror surface, in the liquid state it can be stored in any shape for a given volume.

Although the descriptions above contain many specificities, these should not be construed as limiting the scope of the invention but as merely providing illustrations of some of the presently preferred embodiments of this invention. A subset of other possible implementations is listed under “ALTERNATIVE EMBODIMENTS”. Thus, the scope of the invention should be determined by the appended claims and their legal equivalents, rather than by the examples given.

1. A rheologic mirror comprising:
a. A liquid mirror.
b. Magnetorheologic fluid for use as the liquid in said liquid mirror.
c. A means of producing or removing an appropriate magnetic field in said magnetorheologic fluid.
Whereby said magnetorheologic fluid can be changed in phase.
